(19) United States
(12) Patent Application Publication
(10) Pub. No.: US 2012/0317408 A1
(43) Pub. Date: Dec. 13, 2012

(54) Method and Apparatus for Changing an Operational Characteristic of a Device in Order to Adjust the Power Consumption Level

(75) Inventors: Aki Happonen, Kiiminki (FI); Mika Kuulusa, Tampere (FI)

(73) Assignee: NOKIA CORPORATION, Espoo (FI)

(21) Appl. No.: 13/579,392

(22) PCT Filed: Feb. 25, 2010
(86) PCT No.: PCT/IB10/50835

§ 371 Date: Aug. 16, 2012

(51) Int. Cl. G06F 1/26; G06F 9/00

(52) U.S. Cl. 713/100

(57) ABSTRACT

An apparatus for changing an operational characteristic of a device based at least in part on a user input in order to adjust a power consumption level of the device may include a display for displaying a power consumption indicator corresponding to the power consumption level of the device. The power consumption level may be calculated by a power consumption calculator. A touch interface may receive the user input configured to adjust the power consumption level of the device. An operational characteristic changer may thereby change the operational characteristic. The user input may manipulate the power consumption indicator to adjust the power consumption level to a desired power consumption level. A corresponding method and computer program product are also provided.

### TECHNOLOGICAL FIELD

Embodiments of the present invention relate generally to power management technology and, more particularly, relate to an apparatus, method and a computer program product for changing an operational characteristic of a device based at least in part on a user input in order to adjust the power consumption level of the device.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

With the proliferation of mobile terminals, and given the variety of services beyond just placing phone calls that can be accomplished with mobile terminals, many individuals are finding mobile terminals to be important parts of their work and social lives. Thus, being able to rely upon the availability of the mobile terminal is an important consideration for many users. However, since mobile terminals run on battery power, and since the number of tasks they can be used for are often numerous, battery conservation is a constant concern for mobile terminal users and therefore balancing use of the mobile terminal with power consumption becomes an issue. In this regard, for example, if a user is waiting for a bus or an airplane and wants entertainment, or if a user is lost or has an accident in a remote location, the user would almost certainly like to have as much battery power available as possible despite the fact that the user may have been utilizing the mobile terminal for routine tasks in the meantime. Thus, the saving of battery power is important.

To improve battery life, of course, better batteries could be produced. However, the way in which a device is operated may also influence battery life. Accordingly, many operational factors have been modified in order to assist in increasing battery life. However, prior battery saving techniques have not provided users with the desired level of control over the balance between user terminal functionality and battery life.

Accordingly it may be desirable to provide an improved method and apparatus for changing an operational characteristic of a device based at least in part on a user input in order to adjust the power consumption level of the device.

### BRIEF SUMMARY OF THE INVENTION

A method, apparatus and computer program product are therefore provided that may provide improved adjustment of a power consumption level of a device. Thus, for example, it may be possible to more easily select a desired power consumption level.

In an example embodiment, an improved apparatus comprises at least one processor and at least one memory including computer program code, the at least one memory and the computer program code configured to, with the processor, cause the apparatus to at least perform causing a power consumption indicator corresponding to a power consumption level of a device to be outputted, receiving a user input configured to adjust the power consumption level of the device, and changing an operational characteristic of the device based at least in part on the user input in order to adjust the power consumption level.

In a further example embodiment a computer program product comprises at least one computer-readable storage medium having computer-executable program code portions stored therein, the computer-executable program code portions comprising program code instructions providing for output of a power consumption indicator corresponding to a power consumption level of a device, program code instructions for receiving a user input configured to adjust the power consumption level of the device, and program code instructions for changing an operational characteristic of the device based at least in part on the user input in order to adjust the power consumption level.

Accordingly, embodiments of the present invention may provide for improved adjustment of a power consumption level of a device.

### BRIEF DESCRIPTION OF THE SEVERAL VIEWS OF THE DRAWING(S)

Having thus described the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus for changing an operational characteristic in order to adjust the power consumption level according to an example embodiment of the present invention;

FIG. 3 illustrates a first embodiment of the mobile terminal of FIG. 1 employing the apparatus of FIG. 2 according to an example embodiment of the present invention;

FIG. 4 illustrates a second embodiment of the mobile terminal of FIG. 1 employing the apparatus of FIG. 2 according to an example embodiment of the present invention; and

FIG. 5 illustrates a flowchart according to an example method for changing an operational characteristic in order to adjust a power consumption level of a device in accordance with an example embodiment of the present invention.

### DETAILED DESCRIPTION OF THE INVENTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

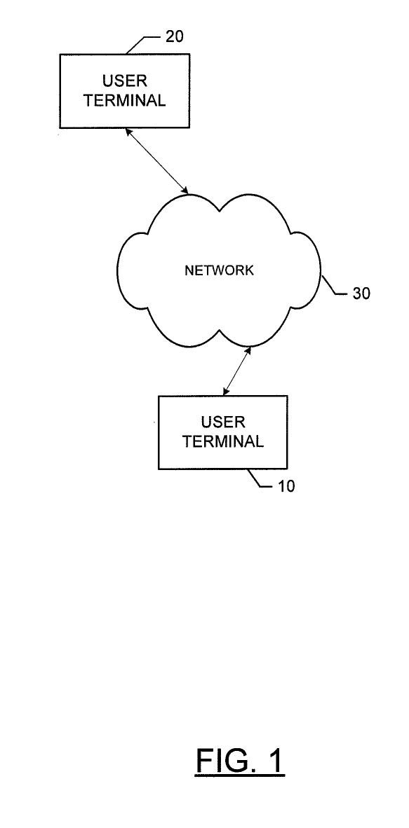

As indicated above, embodiments of the present invention may be employed in methods, apparatuses and computer program products for changing an operational characteristic of a device based at least in part on a user input in order to adjust the power consumption level of the device. In this regard, for example, FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention.

As shown in FIG. 1, an embodiment of a system in accordance with an example embodiment of the present invention may include a user terminal 10. The user terminal 10 may be any of multiple types of fixed or mobile communication and/or computing devices such as, for example, portable digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, and other types of voice and text communications systems, which employ embodiments of the present invention.

In some embodiments the user terminal 10 may be capable of communicating with a communication device 20 which may also comprise a user terminal, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal 10 and/or the other devices may be enabled to communicate with each other, for example, according to numerous communication protocols including Hypertext Transfer Protocol (HTTP) and/or the like, to thereby carry out various communication or other functions of the mobile terminal 10 and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

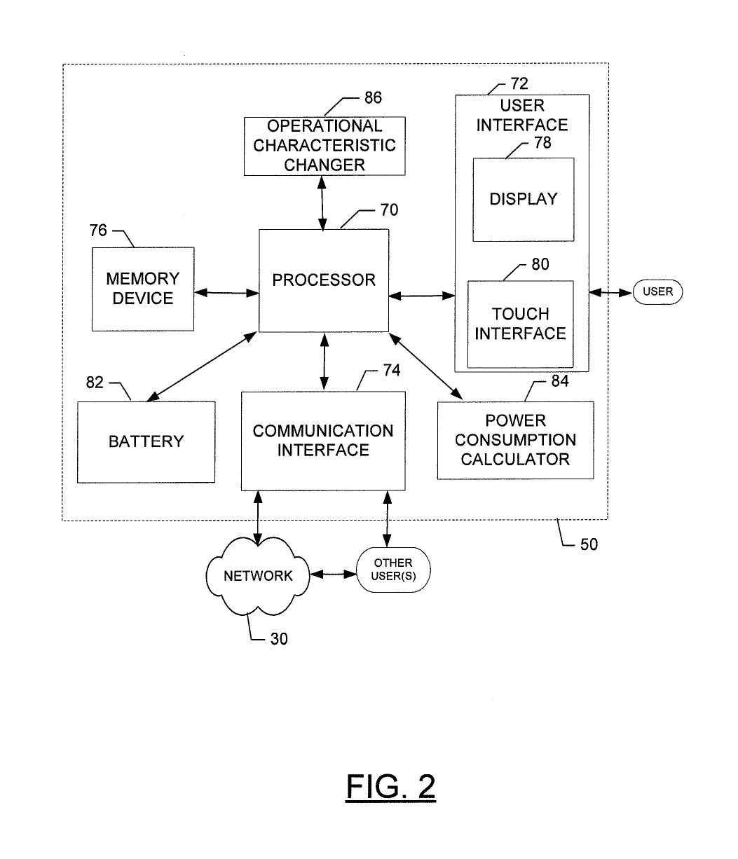

In an example embodiment, an apparatus 50 is provided that may be employed by devices performing example embodiments of the present invention. The apparatus 50 may be embodied, for example, as any device hosting, including, controlling or otherwise comprising the user terminal 10. However, embodiments may also be embodied on a plurality of other devices such as for example where instances of the apparatus 50 may be embodied on the network 30. As such, the apparatus 50 of FIG. 2 is merely an example and may include more, or in some cases less, than the components shown in FIG. 2.

With further regard to FIG. 2, the apparatus 50 is configured to change an operational characteristic of a device, such as the user terminal 10, based at least in part on a user input in order to adjust a power consumption level. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases or storage locations that store information and/or media content.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (for example, a mobile terminal or network device such as a server) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus 50 is embodied as the user terminal 10, the user interface 72 may include a display 78 and a touch interface 80, which may together define a touch screen 78/80. The touch screen 78/80 may thereby be used to control the apparatus 50 and conduct operations associated therewith. In particular, the user interface 72 may be configured to receive a user input configured to adjust the power consumption level of the device. For example, the touch screen 78/80 may be used to manipulate, such as by moving, a power consumption indicator on the touch screen 78/80 to adjust the power consumption level, as will be described below.

In some embodiments the apparatus 50 may include a battery 82, or other power supply. Although the apparatus 50 and associated method and computer program products are generally described herein as being applicable to embodiments in which the power supply may be depleted, in other embodiments the power supply may be substantially capable of powering the apparatus for an unlimited duration. For example, in some embodiments the power supply may comprise a commercial power supply such that electricity is provided by a commercial power plant via power lines. Thus, embodiments may be applicable to applications in which energy consumption is of concern, regardless of the capacity of the power supply.

Accordingly, in some embodiments the apparatus 50 may include a power consumption calculator 84. The processor 70 may be embodied as, include or otherwise control the power consumption calculator 84. The power consumption calculator 84 may employ or embody logic which calculates the power consumption level of the apparatus 50 or other device such as the user terminal 10 when embodied therein. The power consumption calculator 84 may be configured to calculate current power consumption, as well as changes in power consumption based on changes to the operational characteristics of the device, such as changes in the number and type of applications operating. In some embodiments the power consumption calculator 84 may also be configured to calculate the estimated battery life of the device before the battery 82 is depleted. Additionally, in some embodiments the power consumption calculator 84 may be able to calculate a change in the estimated battery life. Further, some embodiments of the power consumption calculator 84 may be configured to calculate the estimated battery life and changes thereto based on the mode of operation of the device, such as operation in a standby mode, internet browsing mode, phone mode, music playing mode, or GPS navigation mode when the device is equipped with such functionality. Also, some embodiments of the power consumption calculator 84 may be configured to calculate a respective application power consumption level for each of the open applications on the device.

In some embodiments the power consumption calculator 84 may make calculations in conjunction with, or responding to, changes implemented by an operational characteristic changer 86. The processor 70 may be embodied as, include or otherwise control the operational characteristic changer 86, which may be configured to change an operational characteristic of the device in order to adjust the power consumption level. Operational characteristics, as described herein, broadly refers to each aspect of the operation of the device. For example, operational characteristics may include the number and type of applications running on the device, the brightness of the display 78, the output level of any audio, the transmission power of the phone, the speed at which the processor 70 is operating, the intervals between sending and/or receiving data with the communication interface 74, etc. For example, some applications, which may be known as standby applications, may update information by sending and/or receiving data during activity periods occurring at regular intervals. Therefore, changing an operational characteristic in some embodiments may comprise changing the interval between which an application sends and/or receives data. In particular, in some embodiments changing the operational characteristic may comprise adjusting the interval at which data is sent and/or received between continuous send/receive and increasing intervals such as every ten minutes, every half hour, every hour, etc. Further, in some embodiments the operational characteristic may be changed such that data is sent and/or received by the application only when manually instructed to do so by the user. Thus, for example, in some embodiments the power consumption calculator 84 may create a power management plan, which may for example include an operational characteristic that will be changed based on the user input received by the touch screen 78/80 and the change in the estimated battery life associated therewith. The operational characteristic changer 86 may thereafter implement the change based at least in part on the user input.

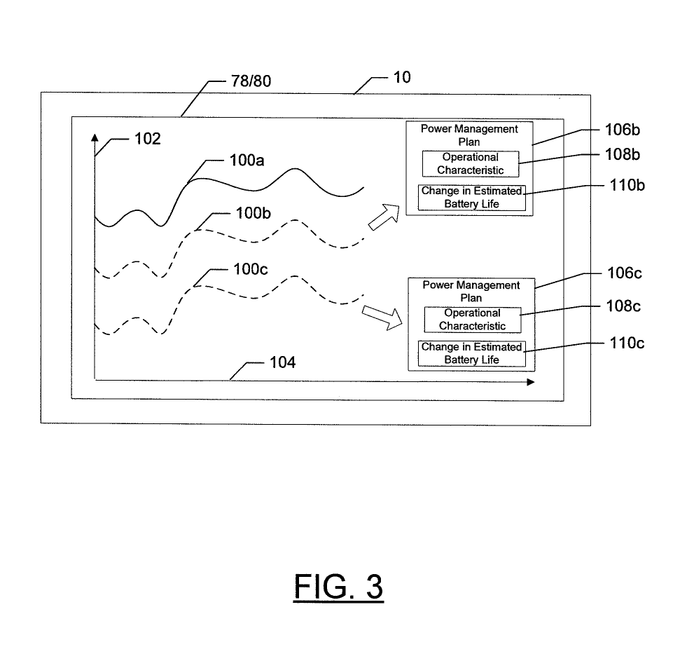

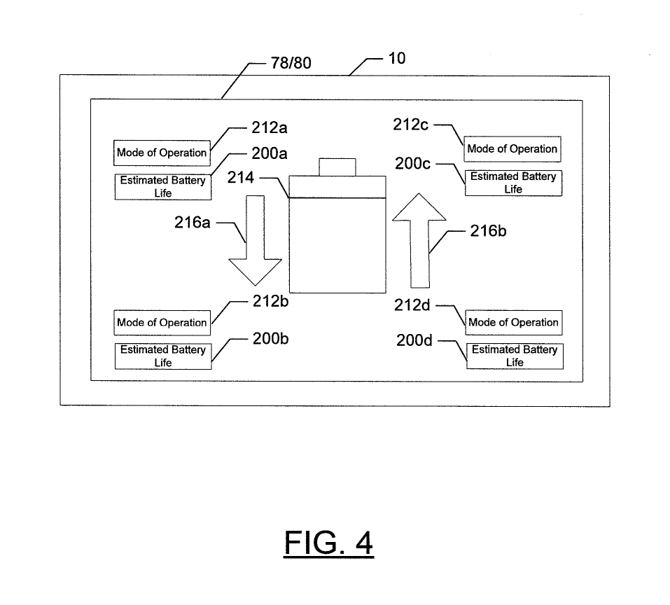

FIGS. 3 and 4 illustrate embodiments of the user terminal 10 when it includes features of the apparatus 50. As illustrated, the user terminal 10 includes the touch screen 78/80, on which a power consumption indicator corresponding to the power consumption level of the device is displayed. In FIG. 3 the power consumption indicator 100a, 100b, 100c (collectively, 100) comprises a graph of power consumption (on the y-axis 102) of the user terminal 10 as recorded over time (on the x-axis 104). The touch screen 78/80 may be used to receive a user input configured to adjust the power consumption level of the user terminal 10. For instance, as illustrated, the touch screen 78/80 may be used to receive a user input which moves the power consumption indicator 100 from a first position 100a, which displays the actual past and current power consumption (as calculated by the power consumption calculator 84) to an intermediate desired power consumption position 100b or a lower desired power consumption position 100c. Thus, one or more operational characteristics may be changed by the operational characteristic changer 86 based at least in part on the user input in order to adjust the power consumption level.

In some embodiments the user terminal 10 may display a power management plan 106b, 106c (collectively 106) corresponding to a respective user input. The power management plant 106 may be created by the power consumption calculator 84. The power management plan 106 may indicate the operational characteristic 108b, 108c (collectively 108) which will be changed based on the user input which is currently provided. The power management plan 100 may further display a change in the estimated battery life 110b, 110c (collectively 110). Thus, for instance, when the user input moves the power consumption indicator 100 to the intermediate desired power consumption position 100b, the power management plan 106b may comprise closing the internet browser (the operational characteristic 108b), which results in an increase in estimated battery life 110b of 50 minutes (for example). By way of further example, when the user input moves the power consumption indicator 100 to the lower desired power consumption position 100c, the power management plan 106c may comprise closing all open applications (the operational characteristic 108c), which results in an increase in estimated battery life 110c of 10 hours (for example). Of course, as discussed above, the power management plan 100 may adjust the interval at which applications send and/or receive data (the operational characteristic 108) as an alternate or additional way of adjusting the power consumption level of the user terminal 10.

The change in estimated battery life 110 may in some embodiments be calculated based on use of the user terminal 10 in a standby mode, for example, whereby the user terminal is ready to perform operations such as receiving a call, but not currently engaged in such operations. Further, the user terminal 10 may be configured such that the power management plan 106 is different for substantially each position at which the power consumption indicator 100 is manipulated by the user input. For instance, the intermediate desired power consumption position 100b and the lower desired power consumption position 100c may be just two examples of a large number of positions corresponding to different power management plans 106 with different changes to operational characteristics 108 resulting in different changes to the estimated battery life 110. In some embodiments the operational characteristic changer 86 may change the operational characteristics 108 immediately upon receiving a user input manipulating the power consumption indicator 100, whereas in other embodiments the operational characteristic changer may wait for the user to release his/her finger from the touch screen 78/80 or confirm selection of the change. Additionally, in some embodiments the user terminal 10 may be configured such that the power management plan 106 provides the user with two or more options which lower the power consumption to the desired power consumption level as selected by the user. For instance, the user terminal 10 could provide the user with two alternative plans which change different operational characteristics 108, or change them in different ways, but which result in substantially the same change to the estimated battery life 110.

FIG. 4 illustrates an alternate embodiment of a power consumption indicator 200a, 200b, 200c, 200d (collectively 200) which comprises an estimated battery life associated with using the user terminal 10 in a specified mode of operation 212a, 212b, 212c, 212d (collectively 212), and which is calculated by the power consumption calculator 84. For instance, a first power consumption indicator 200a may estimate the battery life associated with using the user terminal 10 in the phone mode 212a, whereas a second power consumption indicator 200b may estimate the battery life associated with using the user terminal in the internet browsing mode 212b. Of course, embodiments may display estimated battery life for other modes of operation 212 such as operation in a standby mode, music playing mode, GPS navigation mode, or various other modes when the user terminal 10 is equipped with such functionality. Further, as illustrated, in some embodiments the user terminal 10 may also display a charge indicator 214 which displays the battery power remaining.

With regard to the user input, this may be received by the touch screen 78/80 such as through pressing arrows 216a, 216b (collectively 216) which are configured to change the operational characteristic of the user terminal 10 in order to adjust the power consumption level. Thus, for example, pressing a down arrow 216a may cause the operational characteristic changer 86 to change an operational characteristic such as by closing an open application. Conversely, pressing an up arrow 216b may cause the operational characteristic changer 86 to open an additional application, brighten the display 78, or operate the processor 70 at a faster speed. Thus, some embodiments of the user terminal 10 may adjust the power consumption level without necessarily indicating to the user the operational characteristic which is being changed. However, the embodiment illustrated in FIG. 4 may be modified to indicate the operational characteristic which is being changed.

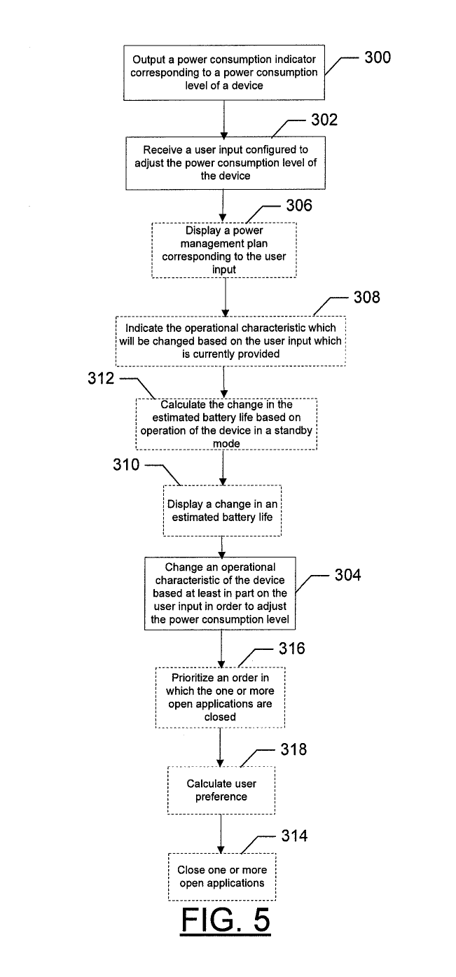

In terms of methods associated with embodiments of the present invention, the above-described apparatus 50 or other embodiments of apparatuses may be employed. In this regard, FIG. 5 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method comprises providing for output of a power consumption indicator corresponding to a power consumption level of a device at operation 300. Providing for output of the power consumption indicator may in some embodiments comprise displaying the power consumption indicator on a display, whereas in other embodiments the power consumption indicator may be outputted in other ways, such as via audio output, for example. Thus, in some embodiments the operation 300 of providing for output of a power consumption indicator corresponding to a power consumption level of a device may be conducted by means, such as the processor 70 or the display 78 in conjunction with the power consumption calculator 84. The method further includes receiving a user input configured to adjust the power consumption level of the device at operation 302, which may be conducted by means, such as the processor 70 or the touch interface 80 in conjunction with the power consumption calculator 84. The device may thereby receive user input manipulating the power consumption indicator, such as by moving it up or down. The method additionally includes changing an operational characteristic of the device based at least in part on the user input in order to adjust the power consumption level, as indicated at operation 304, which may be carried out by means, such as the processor 70 or the operational characteristic changer 86 and in some embodiments the operational characteristic changer may work in conjunction with the power consumption calculator 84. Accordingly, the device may receive user input adjusting the power consumption level to a desired power consumption level.

In some embodiments the method may further include causing display of a power management plan corresponding to the user input at operation 306. Causing display of the power management plan at operation 306 may comprise indicating the operational characteristic which will be changed based on the user input which is currently provided at operation 308. Alternatively or additionally causing display of the power management plan at operation 306 may include causing display of a change in the estimated battery life at operation 310. In some embodiments the method may first comprise calculating the change in the estimated battery life based on operation of the device in a standby mode at operation 312. These operations (306-310) may be conducted by means, such as the processor 70 or the display 78 in conjunction with the power consumption calculator 84.

In some embodiments the operation 304 of changing the operational characteristics may include closing one or more open applications at operation 314, such as by using the processor 70 or the operational characteristic changer 86. Open applications may include programs, software, or other computer readable instructions which are currently in operation. The method may further comprise prioritizing an order in which the one or more open applications are closed at operation 316. The order may be based on a respective application power consumption level of each of the open applications such that in some embodiments the applications which are consuming the most power are closed first, and hence the order may be calculated by the processor 70 or the power consumption calculator 84. Some embodiments may base the order on whether each of the open applications is a background application, and thereby, for example, close the applications which are background applications first. Additionally or alternatively, the order may be based on a user preference. Thus in some embodiments the device may ask the user for his or her user preference as to what and/or how the operational characteristics should be changed. However, in alternate embodiments the method may further comprise determining the user preference at operation 318. Thus, for example, the device may use the processor 70 to recognize from the user's interaction with the device that he or she often uses a weather application. In such cases, the device may determine that the user would prefer that the weather application not be closed. The device may thereby instead determine that the user would find it preferable to close a relatively infrequently used application, such as an application which is open in the background. Although the method has generally been discussed in terms of closing applications in order to change an operational characteristic, as discussed above the method may additionally or alternatively comprise adjusting an interval at which data is sent and/or received by an application.

In an example embodiment, an apparatus for performing the method of FIG. 5 and other methods described above may comprise a processor (for example, the processor 70) configured to perform some or each of the operations (300-318) described above. The processor may, for example, be configured to perform the operations (300-318) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-318 may comprise, for example, the processor 70, the user interface 72 including the display 78 and the touch interface 80, the communication interface 74, the power consumption calculator 84, and the operational characteristic changer 86, and/or an algorithm executed by the processor 70 for processing information as described above. However, the above-described portions of the apparatus 50 as they relate to the operations of the method illustrated in FIG. 5 are merely examples, and it should be understood that various other embodiments may be possible.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one memory including computer program code, the at least one memory and the computer program code configured to, with the processor, cause the apparatus to at least perform:
providing for output of a power consumption indicator corresponding to a power consumption level of a device;
receiving a user input configured to adjust the power consumption level of the device; and
changing an operational characteristic of the device based at least in part on the user input in order to adjust the power consumption level.

2. The apparatus of claim 1, further comprising causing display of a power management plan corresponding to the user input.

3. The apparatus of claim 2, wherein causing display of the power management plan comprises indicating the operational characteristic which will be changed based on the user input which is currently provided.

4. The apparatus of claim 2, wherein causing display of the power management plan comprises causing display of a change in an estimated battery life.

5. (canceled)

6. The apparatus of claim 1, wherein changing the operational characteristic comprises closing one or more open applications and prioritizing an order in which the one or more open applications are closed.

7. (canceled)

8. (canceled)

9. (canceled)

10. (canceled)

11. (canceled)

12. (canceled)

13. The apparatus of claim 1, wherein receiving the user input comprises receiving user input adjusting the power consumption level to a desired power consumption level.

14. A method comprising:
providing for output of a power consumption indicator corresponding to a power consumption level of a device;
receiving a user input configured to adjust the power consumption level of the device; and
changing an operational characteristic of the device based at least in part on the user input in order to adjust the power consumption level.

15. The method of claim 14, further comprising causing display of a power management plan corresponding to the user input.

16. The method of claim 15, wherein causing display of the power management plan comprises indicating the operational characteristic which will be changed based on the user input which is currently provided.

17. The method of claim 15, wherein causing display of the power management plan comprises causing display of a change in an estimated battery life.

18. (canceled)

19. The method of claim 14, wherein changing the operational characteristic comprises closing one or more open applications and prioritizing an order in which the one or more open applications are closed.

20. (canceled)

21. (canceled)

22. (canceled)

23. (canceled)

24. (canceled)

25. (canceled)

26. The method of claim 14, wherein receiving the user input comprises receiving user input adjusting the power consumption level to a desired power consumption level.

27. A computer program product comprising at least one computer-readable storage medium having computer-executable program code portions stored therein, the computer-executable program code portions comprising:
program code instructions providing for output of a power consumption indicator corresponding to a power consumption level of a device;
program code instructions for receiving a user input configured to adjust the power consumption level of the device; and
program code instructions for changing an operational characteristic of the device based at least in part on the user input in order to adjust the power consumption level.

28. The computer program product of claim 27, further comprising program code instructions for causing display of a power management plan corresponding to the user input.

29. The computer program product of claim 28, wherein program code instructions for causing display of the power management plan comprise program code instructions for indicating the operational characteristic which will be changed based on the user input which is currently provided.

30. The computer program product of claim 28, wherein program code instructions for causing display of the power management plan comprise program code instructions for causing display of a change in an estimated battery life.

31. (canceled)

32. The computer program product of claim 27, wherein program code instructions for changing the operational characteristic comprise program code instructions for closing one or more open applications and prioritizing an order in which the one or more open applications are closed.

33. (canceled)

34. (canceled)

35. (canceled)

36. (canceled)

37. (canceled)

38. (canceled)

39. The computer program product of claim 27, wherein recognizing the user input comprises receiving user input adjusting the power consumption level to a desired power consumption level.
